(19) United States
(12) Patent Application Publication
(10) Pub. No.: US 2022/0204320 A1
(43) Pub. Date: Jun. 30, 2022

(54) ELECTRIC MOTOR ASSEMBLIES AND SPINDLE ASSEMBLIES FOR ROTATION

(71) Applicant: PACCAR Inc, Bellevue, WA (US)

(72) Inventors: Stan DELIZO, Lynnwood, WA (US); Mike ROGERS, Tulsa, OK (US); Jacob CONLEY, Broken Arrow, OK (US); Davis CHANG, Kirkland, WA (US)

(21) Appl. No.: 17/139,559

(22) Filed: Dec. 31, 2020

(51) Int. Cl. B66D 1/12; H02K 7/116; B66D 1/14

(52) U.S. Cl. CPC B66D 1/12; B66D 1/22; B66D 1/14; H02K 7/116

(57) ABSTRACT

The present disclosure is directed to a winch assembly that includes a power drive with a motor component. The motor component of the power drive rotates a member within the winch assembly and the rotation of that member is translated to a rotation component (e.g., a spool, a drum, etc.) of the winch assembly to wind up a line, a cord, a rope, a chain, or some other type of line that can be wound up by the winch assembly. The power drive further includes a casing that surrounds and encases the motor component. In some embodiments, the casing of the power drive may be fully encased within the rotation component of the winch assembly. In some embodiments, the casing of the power drive may be partially inset the rotation component. In some embodiments, the casing of the power drive may be external to the rotation component. The motor component is an electric motor that an operator or user can select parameters desired for operation of the winch assembly depending on the situation of use for the winch assembly.

### BACKGROUND

### Technical Field

The present disclosure is directed to a winch with power drive and a rotation component that rotates.

### Description of the Related Art

Generally, vehicles such as cars, trucks, semi-trucks, watercraft, and construction vehicles (e.g., bulldozers, dump trucks, flatbed trucks, road-rollers, front loaders, excavators, cranes, etc.) utilize hydraulic systems to articulate members in operation. These members may be a blade, a ripper, a winch, a sweeper brush, or some other member that is articulated, rotated, contracted, extended, or moved when under power.

There are significant challenges to providing another alternative system that provides power to these articulation members and can still take on the loads that the hydraulic systems rotate, lift, move, drag, push, pull, or articulate when moving the articulation members.

One drawback of hydraulic systems is that generally hydraulic systems take up large quantities of space when mounted to vehicles or utilized within vehicles. For example, complex hydraulic systems generally have several gaskets, tubes, or parts that allow for hydraulic fluid to pass from one location to another to articulate an articulation member.

Another drawback of hydraulic systems is generally hydraulic systems have multiple points at which failure can occur. For example, as discussed earlier, in hydraulic systems, there are several tubes and gaskets that may break, leak, or deteriorate resulting in failure of the hydraulic system as a whole. When failure occurs there are several tubes and gaskets that operators or maintenance employees must inspect to determine the failure. This review is generally time consuming, costly, and difficult to determine a fix or remedy the issue. There is generally no diagnostic system to monitor all of these gaskets and tubes to determine failure in a hydraulic system at a specific location, and, usually, an operator or maintenance employee has to examine the hydraulic system in detail manually to determine the point of failure.

Hydraulic based systems utilize a motor to provide power to move the hydraulic fluid in the system; however, such power is generally non-recoverable energy, which means that no energy put into the system may be recovered by the vehicle and utilized for other applications. In addition, hydraulic based systems provide little to no feedback to an operator without the addition of several sensors and are relatively difficult to control with extreme accuracy or speed due to the viscosity of hydraulic fluid within the hydraulic system.

### BRIEF SUMMARY

Embodiments of the present disclosure address one or more of the drawbacks associated with conventional hydraulic systems. Some embodiments in accordance with the present disclosure are able to reduce the loss of energy by recovering or recuperating energy that has not been utilized to move an articulation member or that has been used to move an articulation member, instead of letting the energy input into the articulation member from dissipating as a lost energy. Some embodiments in accordance with the present disclosure are able to generate energy (e.g., when a user unwinds a rope, cord, chain, cable, or similar line on a spool of a winch causing the spool to rotate, the rotation of the spool can be used to generate energy that is collected by an electric battery or external power source) or regenerate power (e.g., braking a rotating drum, spindle, or spool of a winch assembly to bring the drum, spindle, or spool to a stop). Some embodiments in accordance with the present disclosure have a profile or size that is less than conventional hydraulic systems of the same or similar power rating.

The present disclosure is directed to various embodiments of a device that includes a power drive including an electric motor implemented within a winch, which may be utilized to wind up a rope, cord, chain, cable or similar line for dragging an object or for pulling the vehicle.

In one embodiment, a power drive is mostly inset in a rotation component that the power drive rotates. In one embodiment, the power drive includes an electric motor, and the rotation component is a drum, spindle, or spool of a winch. The power drive includes an articulation member extending outward from the electric motor that mechanically cooperates with the rotation component. “Articulation” being defined as any movement of a component such as rotating, spinning, turning, extending, contracting, or some other type of movement. The articulation member is coupled to of the electric motor and is configured to articulate, rotate, spin, or move the rotation component or another component that may be articulated, turned, extended, contracted, or some other similar movement. As the electric motor of the power drive is powered on and articulates the articulation member, the rotation component rotates in response to the movement of the articulation member. In some embodiments, the power drive is partially inset in the rotation component. In some embodiments, the power drive is not inset in a rotation component and is outside the rotation component. In some embodiments the power drive is fully inset in a rotation component. The various embodiments of the present disclosure can be mounted to a surface of a vehicle.

### BRIEF DESCRIPTION OF THE SEVERAL VIEWS OF THE DRAWINGS

In the drawings, identical reference numbers identify similar elements or acts unless the context indicates otherwise. The sizes and relative proportions of the elements in the drawings are not necessarily drawn to scale.

FIG. 1 is directed to an embodiment of a winch assembly having a power drive external to a rotation component of a winch;

FIG. 2 is directed to an alternative embodiment of a winch assembly having a power drive partially inset in a rotation component of a winch;

FIG. 3 is directed to an alternative embodiment of a winch assembly having a power drive fully inset in a rotation component of a winch;

FIG. 4 is directed to an embodiment of a power drive;

FIGS. 5A-5D are directed to the alternative embodiment of the winch assembly having a power drive partially inset in the rotation component of a winch;

FIGS. 6A-6B are directed to the alternative embodiment of the winch assembly having a power drive mostly inset in the rotation component of a winch;

FIG. 7A-7B are directed to the alternative embodiment of the winch assembly having a power drive fully inset in a rotation component of a winch;

FIG. 8A-8F are directed to a mounting assembly combined with the embodiment of the winch assembly as shown in FIGS. 2 and 5A-5C; and

FIG. 9 is directed to an embodiment of a winch assembly of the present disclosure with a planetary gear set.

### DETAILED DESCRIPTION

In the following description, certain specific details are set forth in order to provide a thorough understanding of various embodiments of the disclosure. However, one skilled in the art will understand that the disclosure may be practiced without these specific details. In other instances, well-known structures and components associated with vehicles such as trucks, cars, construction vehicles, aircraft, watercraft, etc. have not been described in detail to avoid unnecessarily obscuring the descriptions of the embodiments of the present disclosure.

Unless the context requires otherwise, throughout the specification and claims that follow, the word “comprise” and variations thereof, such as “comprises” and “comprising,” are to be construed in an open, inclusive sense, that is, as “including, but not limited to.”

The use of ordinals such as first, second, third, fourth, etc., does not necessarily imply a ranked sense of order, but rather may only distinguish between multiple instances of an act or structure.

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terms “left,” and “right,” are used for only discussion purposes based on the orientation of the components in the discussion of the Figures in the present disclosure as follows. These terms are not limiting as the possible positions explicitly disclosed, implicitly disclosed, or inherently disclosed in the present disclosure.

The term “substantially” is used to clarify that there may be slight differences or variations as for when a surface is coplanar with another surface in the real world, as nothing can be made perfectly equal or perfectly the same. In other words, substantially means that there may be some slight variation in actual practice and instead is made within accepted tolerances.

As used in this specification and the appended claims, the singular forms “a,” “an,” and “the” include plural referents unless the content clearly dictates otherwise.

While various embodiments are shown and described with respect to power drives including electric motors powered by an electrical power source, a casing, and articulation members moved by the electric motor. The power drives are utilized in a winch application to rotate a drum, spindle, or spool for winding and coiling up line, rope, cord, cable, chain, or the like, it will be readily appreciated that embodiments of the present disclosure are not limited thereto and may be applied to applications such as to articulate articulation members or other rotation components. For example, street sweeper brushes, pumps, extending or lifting booms, extending or lifting ladders, extending or lifting platforms, articulating flat beds, articulating dump trucks, etc. In various embodiments, the structures, devices, methods and the like described herein may be embodied in or otherwise utilized in any suitable type or form of a power drive in any vehicle for purposes and applications similar to those set out above and as discussed as follows, and may be manufactured utilizing any suitable manufacturing technologies as desired.

Some embodiments of the present disclosure are directed to an implementation of a power drive, which may include an electric motor, a casing, and an articulation member mechanically cooperating with the electric motor, in a winch assembly. The power drive is positioned in various locations relative to a drum of the winch assembly. For example, the power drive may be external to the drum, may be partially inset within the drum, or may be fully inset, encased, or enclosed within the drum. When the power drive includes an electric motor, the implementation of the electric motor reduces the amount of space the winch assembly takes up on the vehicle or within the vehicle, reduces the number of points of failure within the winch assembly, provides the ability to recuperate power (e.g., regenerative power) or generate power, provides diagnostic capabilities to more easily and readily determine a reason and location of a failure within the winch assembly, and provides a number of parameters and characteristics as feedback or control information allowing the operator to select and control minute details of the winch assembly for situational use.

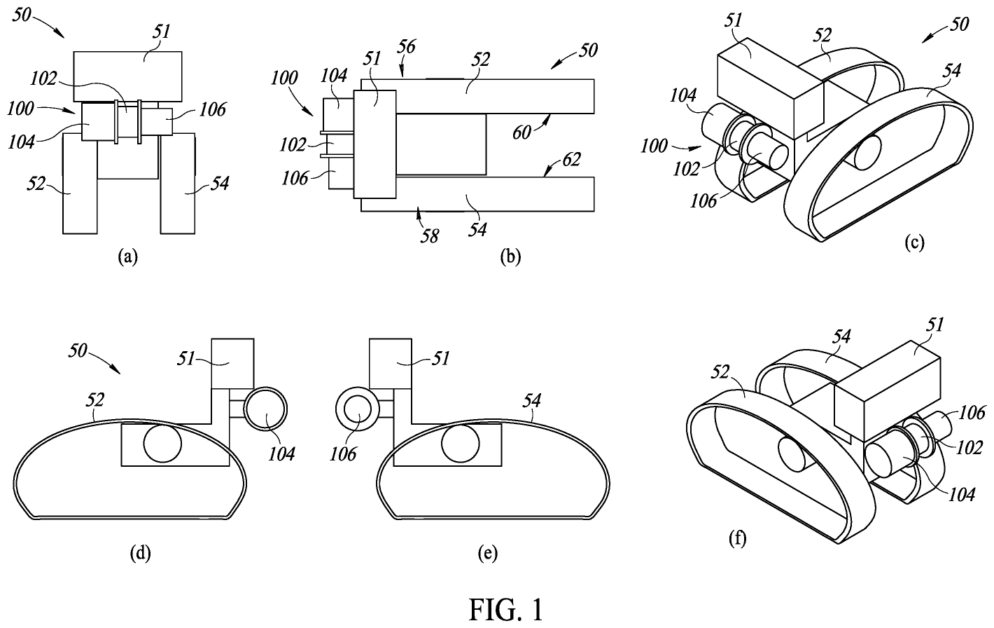

FIG. 1 is directed to an embodiment of a vehicle 50 that includes a body portion 51 that is representative of a frame of the vehicle 50, which may be a bulldozer, a front loader, an excavator, a street sweeper, a boom vehicle, or some other vehicle or construction vehicle. In this embodiment, the vehicle 50 includes a first track 52 on a left-hand side of the vehicle 50 when viewing a rear side of the vehicle 50, and a second track 54 is on a right-hand side of the vehicle 50 opposite to the first track 52 when viewing the rear side of the vehicle 50. The rear side of the vehicle can be seen in FIG. 1(a). The first track 52 has a first external side 56 that faces outward from the vehicle 50 and the second track 54 has a second external side 58 that faces outward from the vehicle and faces away from the first track 52. The first track 52 has a first internal side 60 that faces inward the vehicle 50 towards a second internal side 62 of the second track 54, which also faces inward the vehicle 50.

The vehicle 50 includes a winch assembly 100 that is configured to, in operation, rotate to wind up and coil a line, such as a rope, cord, chain, cable or the like. The winch assembly 100 includes a rotation component 102, which may be referred to as a drum, a spool, a spindle, or some other rotating feature configured to winding up or coiling a line on the rotation component 102. The winch assembly 100 further includes a first component 104 at a first end of the rotation component 102 and a second component 106 at a second end of the rotation component 102. The second end is opposite to the first end. The first component 104 may be a controller, a planetary gear set, a converter, a clutch/locking assembly, or a diagnostic system that interacts with the second component 106, which is an external power drive. The external power drive 106 includes an electric motor that is external to the rotation component 102. When the first component 104 is a clutch/locking assembly, the clutch/locking assembly may be a single clutch assembly, a double clutch, an overrunning clutch, a friction clutch, a wet clutch, a dry clutch, or some other like clutch/locking assembly.

In some embodiments, the first component 104 may be a combination of various components in a fully integrated assembly or a subset of paired components. The components of the fully integrated assembly or the subset of paired components may be a combination of a controller, a converter, a gear set, a clutch/locking assembly, or other similar or like components that are mechanically or electrically cooperating or communicating with each other.

In some embodiments, the second component 106 may be a converter, a controller, a diagnostic system, or some other like component. In some embodiments, the second component 106 may be a combination of a controller, a converter, an electric motor, or some other like component.

When the first component 104 is a planetary gear set, the planetary gear set mechanically cooperates with the electric motor of the external power drive 106 to transfer the rotation of the electric motor to the rotation component 102, which rotates in response to the rotation of the electric motor.

When the first component 104 is a controller, the controller communicates and receives various electrical signals to and from the external power drive 106 to control and monitor the external power drive 106. For example, the first component 104, which is a controller, may control an electric motor, an articulation member, or other features of the external power drive 106. For example, the controller may provide electrical signals to set control limits to avoid overload conditions of the electric motor, to control the rotations-per-minute (RPMs) of the rotation component 102, or to control other parameters and factors of the external power drive 106 or the winch assembly 100 as a whole.

When the first component 104 is a diagnostic system, the diagnostic system monitors the second component 106 and/or the winch assembly 100 as a whole to provide feedback information to an operator or a mechanic with respect to potential failures in the second component 106 or the winch assembly 100 as a whole. For example, the diagnostic system may monitor the power output by the electric motor of the power drive 106 or the power supplied to the electric motor as well as other components of the winch assembly 100 as a whole.

In some embodiments, the winch assembly 100 may include a combination of a diagnostic system, a controller, and a planetary gear set. For example, the winch assembly 100 may include both a controller and a planetary gear set; both a controller and a diagnostic system; a controller, a planetary gear set, and a diagnostic system; or some other combination of components to help control or monitor the winch assembly 100 as a whole. These various combinations may be fully encased, partially encased, or external to the rotation component 102 of the winch assembly 100.

The winch assembly 100 is positioned within a boundary region that extends between the first external side 56 of the first track 52 and the second external side 58 of the second track 54. In other words, the winch assembly 100 is positioned between the first external side 56 and the second external side 58. In this embodiment, the second component 106 overlaps a portion of the second track 54 and the first component 104 overlaps a portion of the first track 52, which is shown in FIG. 1(b). The winch assembly being positioned between these two external sides 56, 58 reduces a likelihood the winch assembly 100 will abut or contact obstacles in an external environment when the vehicle 50 is utilized in difficult or extreme environments, which may be a construction site, a side of a mountain, a lumberyard, or some other location or worksite where several large or small obstacles exist that may damage the winch assembly 100.

In some embodiments, the first component 104 may overlap a portion of the first track 52 and the second component 106 may not overlap the second track 54, the first component 104 may not overlap the first track 52 and the second component 106 may overlap a portion of the second track 54, and the first component 104 may not overlap the first track 52 and the second component 106 may not overlap the second track 54 such that the first component 104 and the second component 106 are entirely positioned between the first track 52 and the second track 54. In other embodiments, the first component 104 overlaps a portion of the first track 52 and the second component 106 overlaps a portion of the second track 54, and the amount of the respective overlap is different.

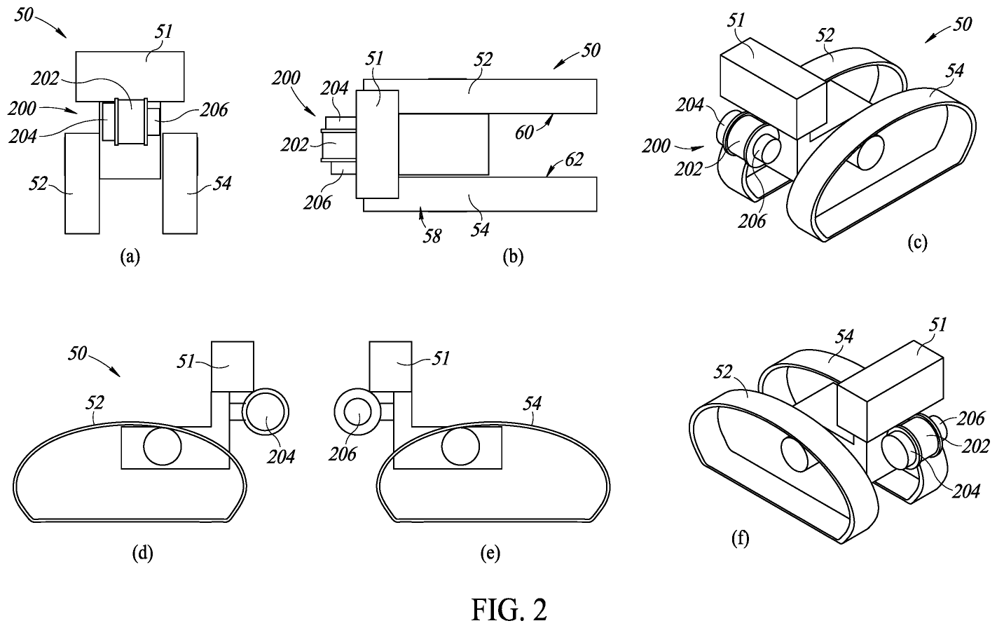

FIG. 2 is directed to an alternative embodiment of a winch assembly 200, which is mounted to the vehicle 50. The winch assembly 200 includes a rotation component 202, a first component 204, and a second component 206. The rotation component 202 is similar to the rotation component 102, the first component 204 is similar to the first component 104, and the second component 206 is similar to the second component 106. For the sake of simplicity and brevity within the present disclosure, the details of these similar components will not be discussed in further detail as the functionality of these components is the same or similar to those previously discussed with the respect to the winch assembly 100 in FIG. 1.

Unlike the winch assembly 100 in FIG. 1, the winch assembly 200 in FIG. 2 is positioned entirely and completely between a boundary region that extends between the first internal side 60 of the first track 52 and the second internal side 62 of the second track 54. In other words, the winch assembly 200 is between the first track 52 and the second track 54 and does not overlap the first track 52 or the second track 54. The winch assembly 200 being entirely and completely between the internal sides 60, 62 of the tracks 52, 54 reduces the likelihood of the winch assembly 200 abutting or contacting external obstacles in the same manner as discussed above with respect to the winch assembly 100 in FIG. 1.

The rotation component 202 of the winch assembly 200 may have a diameter greater than the rotation component 102 of the winch assembly 100. The rotation component 202 with the larger diameter increases an angle at which a rope, a cord, or a line is at when the rope, the cord, or the line is wound up and coiled by the winch assembly 200. The angle is between a tangency line at which the rope, the cord, or the line is at with respect to a surface of the rotation component 202 when the rope, the cord, or the line is wound up by the winch assembly 200 and a ground surface on which the vehicle 50 sits. This increased angle between the tangency line and the ground surface increases leverage and reduces a likelihood of the vehicle 50 tipping over when the rope, the cord, or the line is wound up and coiled by the winch assembly 200.

Unlike the second component 106 of the winch assembly 100, the second component 206 is a power drive partially inset within the rotation component 202. For example, the second component 206 is a power drive that includes an electric motor that is partially within a cavity of the rotation component 202. In other words, the rotation component 202 has an internal surface that partially surrounds the second component 206 such that the second component 206 is partially inset within the cavity of the rotation component 202.

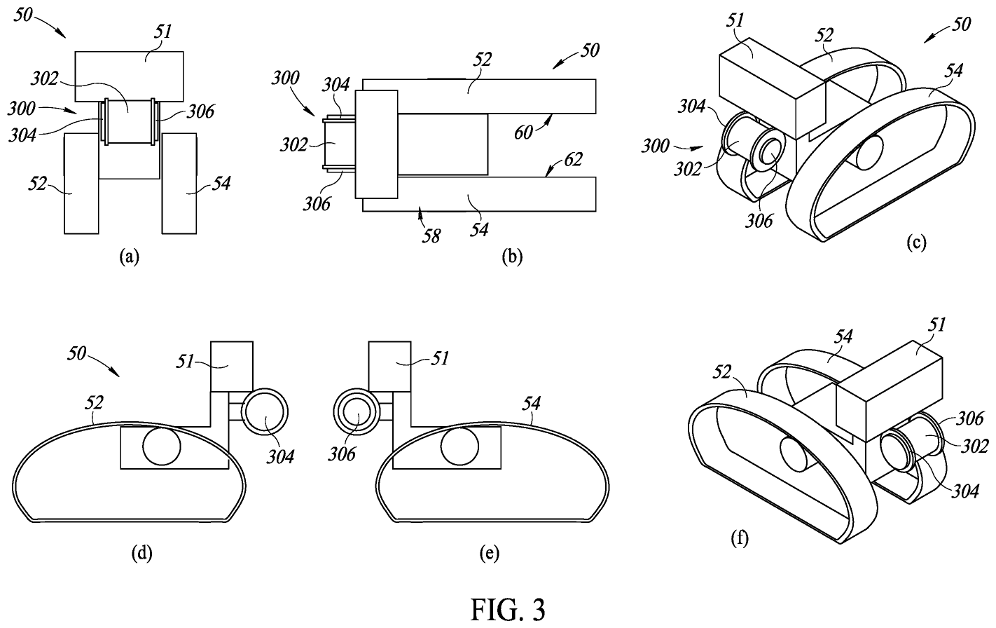

FIG. 3 is directed to an alternative embodiment of a winch assembly 300, which is mounted to the vehicle 50. The winch assembly 300 includes a rotation component 302, a first component 304, and a second component 306. The rotation component 302 is similar to the rotation components 102, 202, the first component 304 is similar to the first components 104, 204, and the second component 306 is similar to the second components 106, 206. For the sake of simplicity and brevity within the present disclosure, the details of these similar components will not be discussed in further detail as the functionality of these components is the same or similar to those previously discussed with the respect to the winch assemblies 100, 200 in FIGS. 1 and 2.

Unlike the second components 106, 206 of the winch assemblies 100, 200, the second component 306 is a power drive mostly or entirely inset within the rotation component 302. For example, in some embodiments, the second component 306 includes an electric motor that is entirely within a cavity 347 of the rotation component 302. In other words, the rotation component 302 has an internal surface that mostly surrounds the second component 306 such that the second component 306 is mostly inset within the rotation component 302. The rotation component 302 may be referred to as a housing, a drum, a spindle, a spool, or some other component that rotates. In some embodiments, the rotation component 302 may fully surround, encase, or enclose the first component 304 and the second component 306. In some of the embodiments, the first component 304 may be fully surrounded, encased, or enclosed within the rotation component 302, and the second component 306 may be partially inset the rotation component 302. In some embodiment the second component 306 may be fully surrounded, encased, or enclosed within the rotation component 302, and the first component 304 may be partially inset the rotation component 302. In some embodiments, both the first component 304 and the second component 306 may be partially inset the rotation component 302 but extend outward from the rotation component by different amounts.

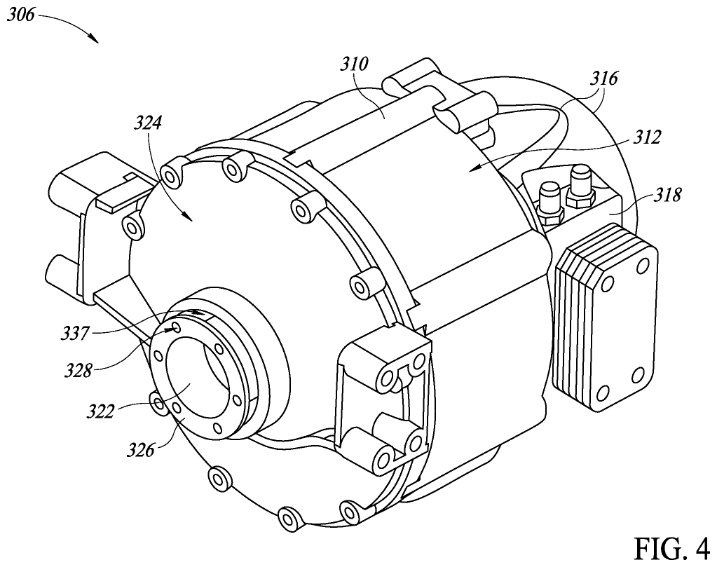

FIG. 4 is directed to an example of the second component 306 of the winch assembly 300. The second components 106, 206 of the winch assemblies 100, 200 may be substantially the same as the second component 306 of the winch assembly 300. Accordingly, the following discussion with respect to the second component 306 of the winch assembly 300 also applies to the second components 106, 206 of the winch assemblies 100, 200. As discussed earlier, the second component 306 in the following description is referred to as a power drive 306.

The power drive 306 in FIG. 4 includes a casing 310, an electric motor, and an articulation member. The casing surrounds the electric motor, which is not visible in FIG. 4 as the casing 310 surrounds the electric motor. The casing 310 has an external surface 312 and an internal surface, which is not visible in FIG. 4, that surrounds the electric motor and a cavity in which the electric motor is positioned within the casing 310 of the power drive 306.

The power drive 306 further includes electrical lines 316, e.g., wires, cables, or the like that are electrically coupled to the motor of the power drive 306. The electrical line or lines 316 are coupled to electrical connections 318 that are outside the casing 310 and are accessible such that the power drive 306 may be coupled to an external controller configured to, in operation, turn the power drive 306 on and off and control other parameters and factors at which the power drive 306 may operate. An operator may be able to access these parameters through the external controller which may be a user interface to select, manage, and control the power drive as preferred to select parameters for situational use. For example, the external controller may be a dashboard, a control panel, a remote control, a digital interface, an analog interface, touch screen interface, a wireless interface, or some other input controller, external controller, or user interface. Electrical lines 316 also connect the power drive 306 to a source of electrical energy, such as a generator, an alternator, a battery bank, or some other power source or electrical device. The electrical lines 316 remain stationary relative to the power drive 306 such that the electrical lines 316 do not break when the power drive 306 is powered on to rotate a drum of a winch assembly.

The power drive 306 further includes an opening 337 at an end of the power drive 306 and an articulation component 322 that extends through the opening 337. The articulation component 322 will be referred to as a shaft 322 henceforth within the present disclosure. The opening 337 extends through a side surface 324 of the external surface 312 to the internal surface of the casing 310. The shaft 322 is mechanically coupled to the electric motor in the casing 310. The shaft 322 includes an end 326 that is outside the casing 310. The end 326 of the shaft includes openings 328 that are configured to receive fasteners, which may be snap fit fasteners, screws, nuts, rivets, bolts, or some other type of fastener or combination of fasteners.

In some embodiments, the shaft 322 is a hollow shaft and the electrical line or lines 316 extend through the hollow portion of the shaft to reach and be electrically coupled to the electric motor within the power drive 306.

In some embodiments, the casing 310 includes openings extending from the internal surface to the external surface to access the cavity within the casing 310, and the electrical lines 316 extend through the openings in the casing 310 to be electrically coupled to the electric motor.

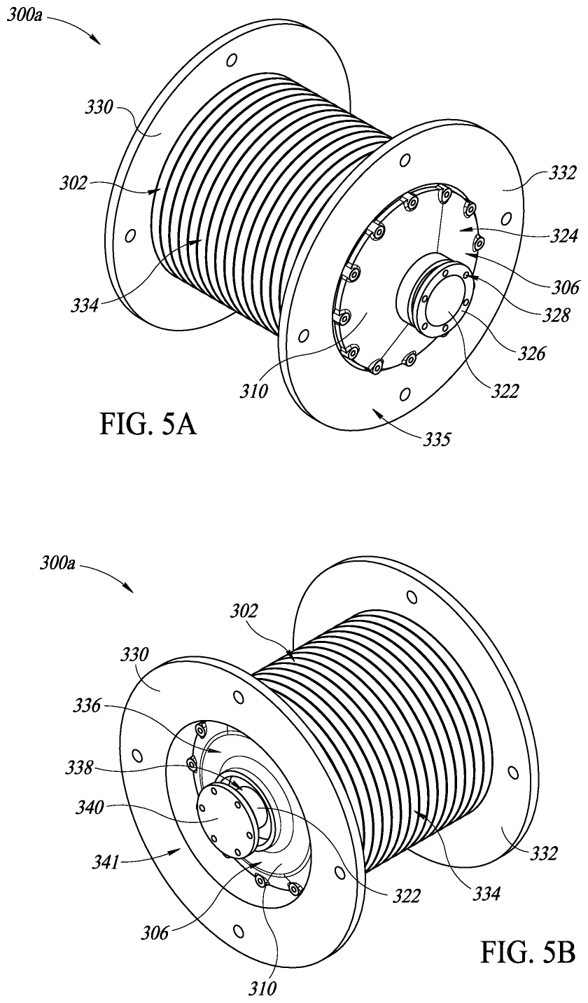

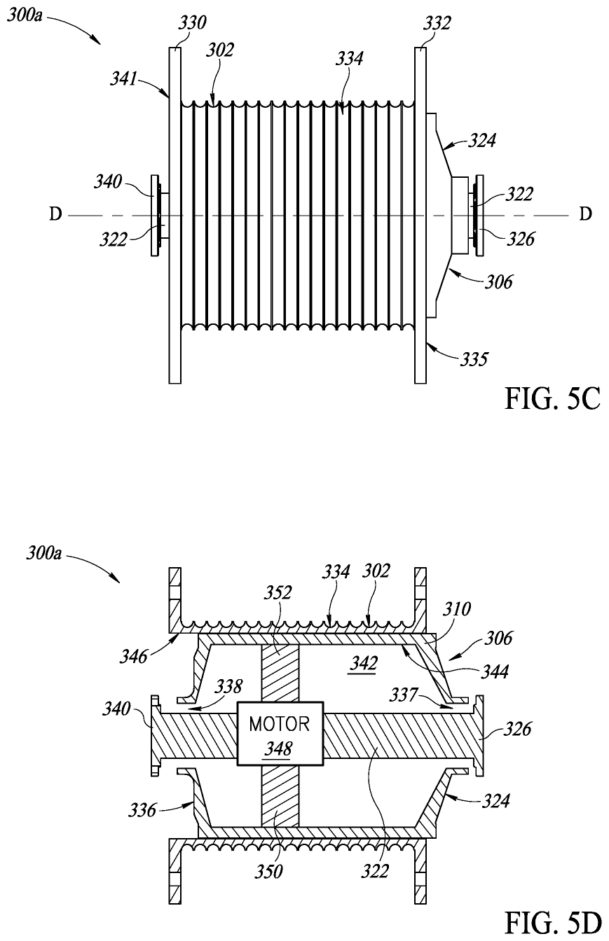

FIGS. 5A and 5B are directed to perspective views of a first embodiment 300a of the winch assembly 300 in FIG. 3 with the power drive 306 being mostly inset in the rotation component 302 as shown and discussed with respect to FIG. 3. FIGS. 5A and 5B show additional details of the first embodiment 300a, which were not shown in FIG. 3. These additional details will be discussed further, however, details already previously discussed with respect to the winch assembly 300 will not be discussed in further detail.

FIG. 5A is directed to a first perspective view of the first embodiment 300a of the winch assembly 300. The rotation component 302 includes a first flange 330 at a first end of the rotation component 302, and a second flange 332 opposite to the first flange 330 at a second end of the rotation component 302 opposite to the first end. A ridged surface 334 extends from the first flange 330 to the second flange 332. The flanges 330, 332 act as boundary portions for a rope, a cord, a line, or the like to be wound up and coiled on the ridged surface 334. The ridged surface 334 is a part of an external surface of the rotation component 302.

The rotation component 302 surrounds the external surface 312 of the power drive 306. However, the side surface 324 of the power drive 306 is exposed at an end 335 of the rotation component 302 and the end 326 of the shaft 322 is accessible and uncovered at the second end of the rotation component 302. The shaft 322 extends through an opening 337 in the casing 310, which can be seen in FIG. 5D. In some embodiments, the side surface 324 may be slightly protruding from the end 335 of the rotation component 302.

In some embodiments, the rotation component 302 fully encloses or encases the casing 310 of the power drive 306 such that the side surface 324 of the power drive 306 is not exposed and instead is internally within the rotation component 302 and is covered by the rotation component 302. In some embodiments, a hinged lid with openings or a removable lid with openings may be utilized to fully encase the power drive 306 while leaving the shaft 322 exposed and at the same time providing an operator the ability to access the power drive 306 in case of repairs, maintenance, or replacement.

FIG. 5B is directed to a second perspective view of the first embodiment 300a. The power drive 306 is mostly inset in the rotation component 302 as shown and discussed with respect to FIG. 3. The power drive 306 includes a side surface 336 of the external surface 312 that is opposite to the side surface 324. The side surface 336 includes an opening 338 that extends through the side surface 336 to the internal surface of the power drive 306 to the cavity within the power drive 306. The shaft 322 extends through the opening 338 and has an end 340 opposite to the end 326 that is exposed at an end 341 of the rotation component 302 opposite to the end 335 of the rotation component 302. The side surface 336 of the power drive 306 may be recessed within the rotation component 302 such that the side surface 336 is between the ends 335, 341 of the rotation component 302.

In some embodiments, both side surfaces 324, 336 of the power drive 306 may be both recessed within the rotation component 302. In some embodiments, both side surfaces 324, 336 may be covered by hinged lids with openings or removable lids with openings that are at ends of the rotation component 302 to fully enclose or encase the power drive 306 within the rotation component 302. In some embodiments, both side surfaces 324, 336 of the power drive 306 may protrude outward from the power drive 306.

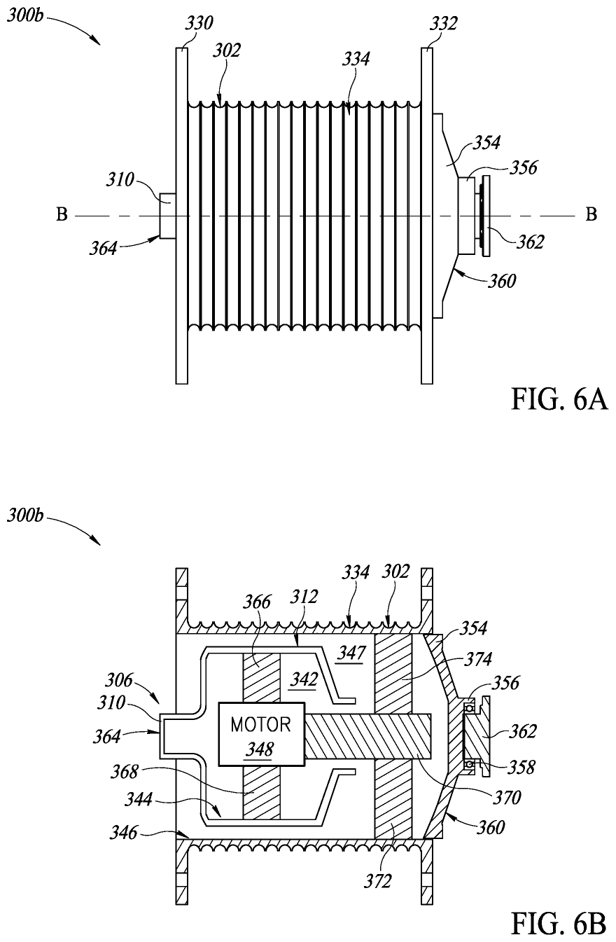

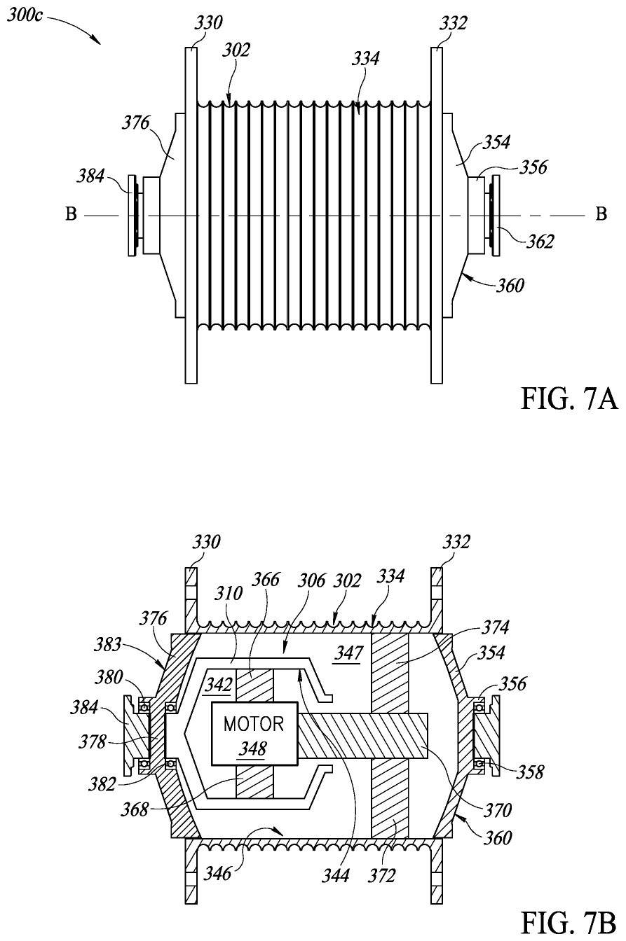

FIG. 5C is a side view of the first embodiment 300a and FIG. 5D is a cross-sectional view taken along line D-D in FIG. 5C. The power drive 306 has the cavity 342 that is surrounded by the internal surface 344 of the casing 310 of the power drive 306. The external surface 312 of the power drive 306 is adjacent and abutting an internal surface 346 of the rotation component 302 that surrounds the power drive 306. The casing 310 is coupled to the rotation component 302 such that the casing 310 and the rotation component 302 rotate together when the power drive 306 is turned on. The casing 310 may be coupled to the internal surface 346 of the rotation component 302 by a plurality of fasteners (e.g., set screws, screws, nuts, bolts, rivets, etc.). The internal surface 346 surrounds a cavity 347 that the power drive 306 is positioned, which can be seen more clearly in FIGS. 6B and 7B

The power drive 306 includes a motor component 348 (e.g., an electric motor) that the shaft 322 passes through. The shaft 322 mechanically cooperates with the motor component 348 such that when the shaft 322 is fixed in place and the motor component 348 is turned on, the motor component 348 rotates about the shaft 322. The power drive 306 further includes a first articulation component 350 on a first side of the motor component 348 and mechanically coupled to the motor component 348, and a second articulation component 352 on a second side of the motor component 348 opposite to the first side and mechanically coupled to the motor component 348. The first articulation component 350 and the second articulation component 352 will be referred to as a first articulation member 350 and a second articulation member, respectively, henceforth within the present disclosure. The first articulation member 350 and the second articulation member 352 are coupled to the internal surface 344 of the casing 310. When the motor component 348 is turned on, the motor component 348 rotates about the shaft 322 rotating the first and the second articulation members 350, 352, the rotation of the first and the second articulation member 350, 352 rotates the casing 310, and the rotation of the casing 310 rotates the rotation component 302 to wind up and coil a line rope, a cord, a chain, or the like on the rotation component 302.

While the shaft 322 and the articulation members 350, 352 are shown as drive shafts or physical members that are mechanically coupled to other features of the first embodiment 300a and that extend outward from the motor component 348, it will be readily appreciated that the shaft 322 and the articulation members 350, 352 may be replaced by a plurality of interacting gears that are positioned within the casing 310 and the rotation component 302. The plurality of interacting gears interact and mechanically cooperate with each other to transfer a torque output by the motor component 408 to the casing 310, which rotates both the casing 310 and the rotation component 302. For example, if the shaft 322 and the articulation members 350, 352 are a plurality of gears, the gears interact with each other and mechanically cooperate with each other to transfer a torque output by the motor component to the casing 310 rotating the casing 310 and the rotation component 302.

In some embodiments, the shaft 322 and the articulation members 350, 352 may be combined with a plurality of gears that assist in the transfer of a torque output by the motor component 348 to the casing 310, which rotates both the casing 310 and the rotation component 302.

In some embodiments, the shaft 322 and the articulation members 350, 352 may be combined with a plurality of gears and pulleys that assist in the transfer of a torque output by the motor component 348 to the rotation component 302, which rotates the rotation component 302.

When a plurality of gears either replace or are utilized in combination with the shaft 322 and the articulation members 350, 352, the plurality of gears either alone or in combination with the shaft 322 and the articulation members 350, 352 act and perform as a multi-drive gear set such that the speed of rotation of the casing 310 and the rotation component 302 is not limited by a maximum torque output capacity of the motor component 348. For example, a combination of gears of different sizes may be selected to increase or decrease maximum or minimum rotation speed of the casing 310 and the rotation component 302 relative to the maximum torque output capacity of the motor component 348.

When only the shaft 322 and the articulation members 350, 352 are utilized in combination with the motor component 348 to rotate the casing 310 and the rotation component 302, the shaft 322, the articulation members 350, 352, and the motor component 348 directly drive the rotation of the casing 310 and the rotation component 302.

When the plurality of gears either replace or are combined with the shaft 322 and the articulation members 350, 352 are utilized in combination with the motor component 348 to rotate the casing 310 and the rotation component 302, the plurality of gears either alone or in combination with the shaft 322 and the articulation members 350, 352 indirectly drive the rotation of the casing 310 and the rotation component 302.

FIGS. 6A-6B are directed to a second embodiment 300b of the winch assembly 300 as seen in FIG. 3. In the interest of brevity and simplicity sake of the present disclosure, only differences or additional details with respect to the second embodiment 300b in FIGS. 6A-6B as compared to the first embodiment 300a in FIGS. 5A-5D will be discussed in further detail as follows. The same or similar features in FIGS. 6A-6B as those in FIGS. 5A-5D have been labeled with the same reference numerals.

FIG. 6A is directed to a side view of the second embodiment 300b. The rotation component 302 includes a cover 354, which may be a hinged cover, a removable cover, or some other cover or access point that an operator or maintenance employee can open and close to access components within the rotation component 302. When opened, the cover 354 provides access to the power drive 306 such that the operator or maintenance employee may replace, remove, or access the power drive 306 for maintenance purposes; and, when closed, the cover 354 protects sensitive components within the rotation component 302 from outside debris or obstacles that could damage the sensitive components within the rotation component 302. These sensitive components may include the power drive 306 as well as other electrical components or connections within the rotation component 302. The cover 354 includes a reception portion 356 that that extends away from a side surface 360 of the cover 354. The reception portion 356 receives a bearing component 358, which can be seen on the right-hand side of FIG. 6B, and a mounting component 362, which protrudes outward from the right-hand side of the reception portion 356.

The bearing component 358 provides a degree of freedom such that the rotation component 302 rotates about the mounting component 362 and about an axis defined by line B-B. While the bearing component 358 provides the degree of freedom such that the rotation component 302 rotates, the mounting component 362 can be utilized to mount the second embodiment 300b to a vehicle in a stationary position. For example, the mounting component 362 may be mounted or physically coupled to a vehicle by fasteners (e.g., set-screws, screws, nuts, bolts, rivets, etc.), by welding the mounting component to a mounting system that is mounted to a vehicle, or by some other manner that the mounting component 362 may be mounted or coupled to a vehicle. In other words, the bearing component 358 and the mounting component 362 work together to fixedly mount the second embodiment 300b to a vehicle while providing the degree of freedom such that the rotation component 302 may rotate about the axis defined by line B-B.

The casing 310 of the power drive 306, which can be seen in FIG. 6B, includes an end 364 that protrudes outward from the rotation component 302. The end 364 is configured to be mounted or physically coupled to a vehicle to mount the second embodiment 300b to the vehicle. The end 364 that may be coupled to or mounted to the vehicle by fasteners (e.g., set-screws, screws, nuts, bolts, rivets, etc.) or in some other fashion such that the power drive 306 is removable and can be replaced.

FIG. 6B is directed to a cross-sectional view taken along line B-B in FIG. 6A. The power drive 306 is within the rotation component 302. However, unlike in the first embodiment 300a where the casing 310 is coupled to the rotation component 302 and the external surface 312 is adjacent and abutting the internal surface 346 of the casing 310 as shown in FIG. 5D, the external surface 312 of the casing 310 in the second embodiment 300b is not adjacent or abutting the internal surface 346 of the rotation component 302. Instead, the external surface 312 of the casing 310 is spaced apart from the internal surface 346 of the rotation component 302.

The second embodiment 300b includes a first articulation component 366, a second articulation component 368, a third articulation component 370, a fourth articulation component 372, and a fifth articulation component 374. These articulation components 366, 368, 370, 372, 374 will be referred to as articulation members 366, 368, 370, 372, 374, respectively, henceforth within the present disclosure.

The bearing component 358 as discussed earlier surrounds and physically contacts a portion of the mounting component 362, which is adapted to be coupled to a mounting system to attach the second embodiment 300b to a vehicle. The bearing component 358 provides the degree of freedom such that the rotation component 302 can rotate to wind up and coil a line, a cord, a rope, a chain, or the like on the rotation component 302.

The power drive 306 includes a first member 366 that extends from the internal surface 344 of the casing 310 to a first side of the motor component 348 and a second member 368 that extends from the internal surface 344 of the casing 310 to a second side of the motor component 348. The first side is opposite to the second side. The first member 366 and the second member 368 fixedly couple the motor component 348 to the internal surface 344 of the casing 310 such that the motor component 348 is in a stationary position within the casing 310. The third member 370, e.g., a shaft to be driven by motor 348, extends outward from the motor component 348 and is transverse to the first and second members 366, 368. A fourth member 372 is coupled to the third member 370 and a fifth member 374 is coupled to the third member 370. The fourth and fifth members 372, 374 extend from the third member 370 to the internal surface 346 of the rotation component 302. The fourth and fifth members 372, 374 are coupled to the third member 370 and the internal surface 346 of the rotation component 302. When the power drive 306 is turned on, the motor component 348 rotates the third member 370, and the rotation of the third member 370 is translated to the rotation component 302 through the fourth and fifth members 372, 374, which rotate with the third member 370.

In some embodiments, the third member 370 is coupled to the fourth and fifth members 372, 374 in a manner such that the power drive 306 is removable from the rotation component 302 in order to be replaced upon failure, and the fourth and fifth members 372, 374 are fixedly coupled to the internal surface 346 of the rotation component 302. For example, the third member 370 may be coupled to the fourth and fifth members 372, 374 by fasteners (e.g., set-screws, screws, bolts, rivets, etc.) or by some other means that allows for the power drive 306 to be removable from within the rotation component 302.

In some embodiments, the third member 370 is fixedly coupled to the fourth and fifth members 372, 374, and the fourth and fifth members 372, 374 are coupled to the rotation component 302 in a manner such that the power drive 306 is removable from the rotation component 302. For example, the fourth and fifth member 372, 374 may be coupled to the rotation component 302 by fasteners (e.g., set-screws, screws, bolts, rivets, snap-fit, etc.) or by some other means that allows for the power drive 306 to be removable from within the rotation component 302.

In some embodiments, the third member 370 is coupled to the fourth and fifth members 372, 374 by fasteners (e.g., set screws, screws, bolts, rivets, snap-fit, etc.), and the fourth and fifth members 372, 374 are coupled to the rotation component 302 by fasteners (e.g., set screws, screws, bolts, rivets, etc.) as well. In these embodiments, the power drive 306 is removable from within the rotation component 302, and the fourth and fifth members 372, 374 are removable from within the rotation component 302 as well.

In some embodiments, the third member 370, the fourth member 372, and the fifth member 374 may be made of a single, continuous material, and ends of the fourth and fifth members 372, 374 are coupled to the rotation component 302 by fasteners (e.g., set screws, screws, bolts, rivets, snap-fit, etc.) such that the power drive 306 is removable from within the rotation component 302.

In some embodiments, the power drive 306 may be external to the rotation component 302. In other words, the casing 310 may be entirely, fully, or completely outside the internal cavity 347 of the rotation component 302 such that the casing 310 is not surrounded by the internal surface 346 of the rotation component 302, and the third member 370 extends into the internal cavity 347 of the rotation component 302.

While the members 366, 368, 370, 372, 374 are shown as drive shafts or physical members that are mechanically coupled to other features of the second embodiment 300b and that extend outward from the motor component 348, it will be readily appreciated that the members 366, 368, 370, 372, 374 may be replaced by a plurality of gears, a plurality of gears and pulleys, or a some other combination of other similar components positioned within the casing 310 and the rotation component 302 configured to transfer a torque output from the motor component 348 to the rotation component 348 rotating the rotation component 302. For example, if the members 366, 368, 370, 372, 374 are a plurality of gears, the gears interact with each other and mechanically cooperate with each other to transfer a torque output by the motor component 348 to the rotation component 302 rotating the rotation component 302.

In some embodiments, the members 366, 368, 370, 372, 374 may be combined with a plurality of gears that assist in the transfer of a torque output by the motor component 348 to the rotation component 302, which rotates the rotation component 302.

In some embodiments, the members 366, 368, 370, 372, 374 may be combined with a plurality of gears and pulleys that assist in the transfer of a torque output by the motor component 348 to the rotation component 302, which rotates the rotation component 302.

When a plurality of gears either replace or are utilized in combination with the members 366, 368, 370, 372, 374, the plurality of gears either alone or in combination with the members 366, 368, 370, 372, 374 act and perform as a multi-drive gear set such that the speed of rotation of the rotation component 302 is not limited simply by a maximum torque output capacity of the motor component 348. For example, a combination of gears of different sizes may be selected to increase or decrease the maximum or minimum rotation speed of the rotation component 302 relative to the maximum torque output capacity of the motor component 348.

When only the members 366, 368, 370, 372, 374 are utilized in combination with the motor component 348 to rotate the rotation component 302, the members 366, 368, 370, 372, 374 and the motor component 348 directly drive the rotation of the rotation component 302.

When the plurality of gears either replace or are combined with the members 366, 368, 370, 372, 374 are utilized in combination with the motor component 348 to rotate the rotation component 302, the plurality of gears either alone or in combination with the members 366, 368, 370, 372, 374 indirectly drive the rotation of the casing 310 and the rotation component 302.

FIGS. 7A-7B are directed to a third embodiment 300c of the winch assembly 300. In the interest of brevity and simplicity sake of present disclosure, only differences or additional details with respect to the third embodiment 300c as compared to the first and second embodiments 300a, 300b as shown in FIGS. 5A-5D and 6A-6B will be discussed in further detail as follows. The same or similar features in FIGS. 7A-7B as those in FIGS. 5A-5D and 6A-6B have been labeled with the same reference numerals.

Unlike the power drives 306 in the embodiments of the winch assemblies 300 in FIGS. 5A-5D and 6A-6B, the power drive 306 in FIGS. 7A-7B is fully encased and enclosed within the rotation component 302.

Unlike the rotation component 302 in FIGS. 6A-6B, the rotation component 302 in FIGS. 7A-7B has another cover 376 that is on the left-hand side of the rotation component 302 in FIGS. 7A-7B. The cover 354 is on the right-hand side of the third embodiment 300c as shown in FIGS. 7A-7B, which is the same positioning of the cover 354 in the second embodiment 300b as shown in FIGS. 6A-6B. The cover 376 functions in a similar or same manner as the cover 354 as discussed above with respect to FIGS. 6A-6B.

In the third embodiment 300c, the reception portion 356 and the bearing component 358 are at a first end of the rotation component 302, which is on the right-hand side of FIG. 7B, and another reception portion 378 is at a second end of the rotation component 302, which is on the left-hand side of FIG. 7B. Bearing components 380, 382 are received by the reception portion 378 at the second end of the rotation component 302. A first portion of the reception portion 378 that receives the bearing component 380 extends away from a side surface 383 of the cover 376, and the side surface 383 is part of the external surface of the rotation component 302. A second portion of the reception portion 378 that receives the bearing component 382 is within the internal cavity 347 and is part of the internal surface 346 of the rotation component 302. Another mounting component 384 is mechanically cooperating with the bearing component 380 and the casing 310 is mechanically cooperating with the bearing component 382.

In a similar or same fashion as discussed earlier with respect to the bearing component 358 providing the degree of freedom such that the rotation component 302 rotates about the third member 370, the bearing component 380 provides a degree of freedom such that the rotation component 302 may rotate about the third member 370 and the power drive 306, and rotate with the third member 370. Conversely, the bearing components 380, 382 provides a degree of freedom such that the casing 310 and the mounting component 384 do not rotate with the rotation component 302, and, instead, stay in a stationary position relative to the rotation of the rotation component 302.

In the same or similar fashion as discussed earlier with respect to FIG. 6B, the members 366, 368, 370, 372, 374 may be replaced by a plurality of gears, may be replaced by a plurality of gears and pulleys, may be combined with either a plurality of gears, or may be combined with a plurality of gears and pulleys. For the sake of simplicity and brevity of the present disclosure, the earlier discussion with respect to the members 366, 368, 370, 372, 374 as discussed earlier with respect to FIG. 6B will not be reproduced here.

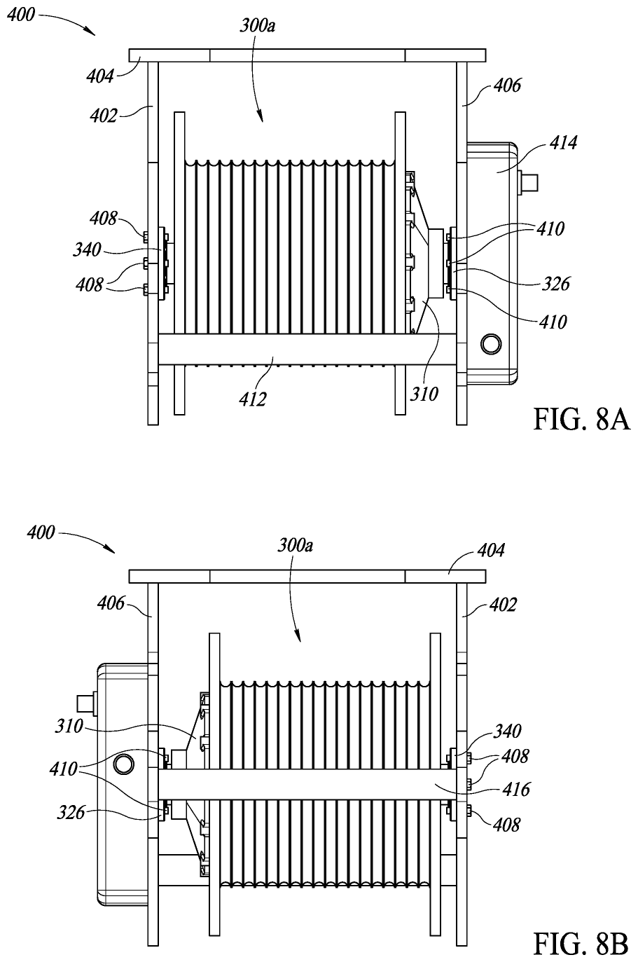

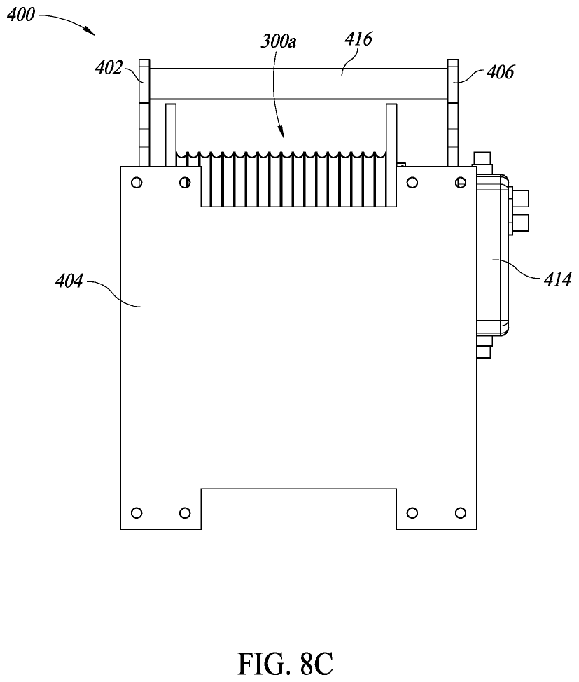

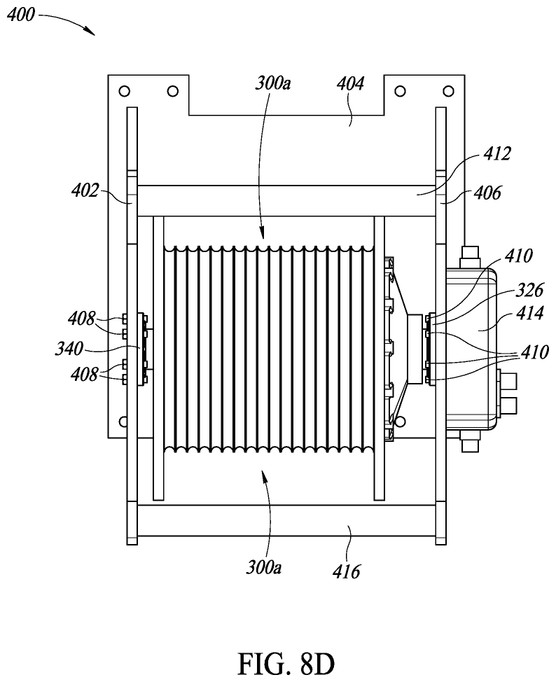

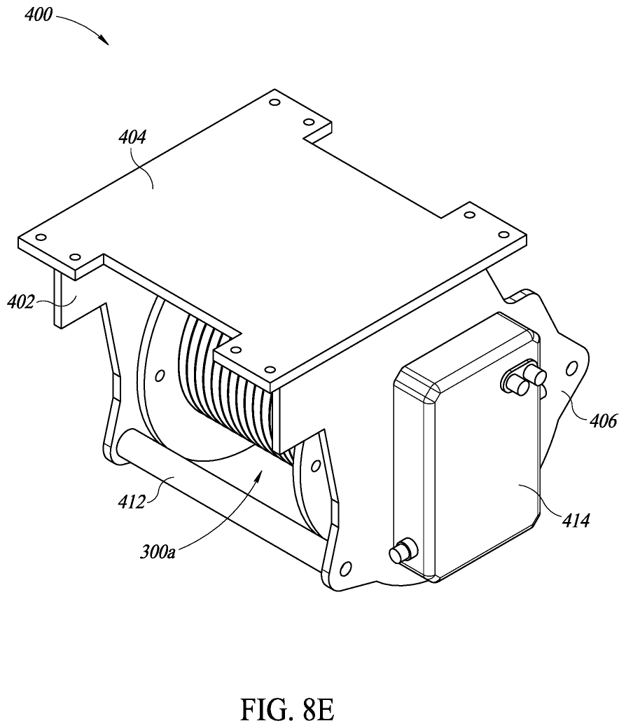

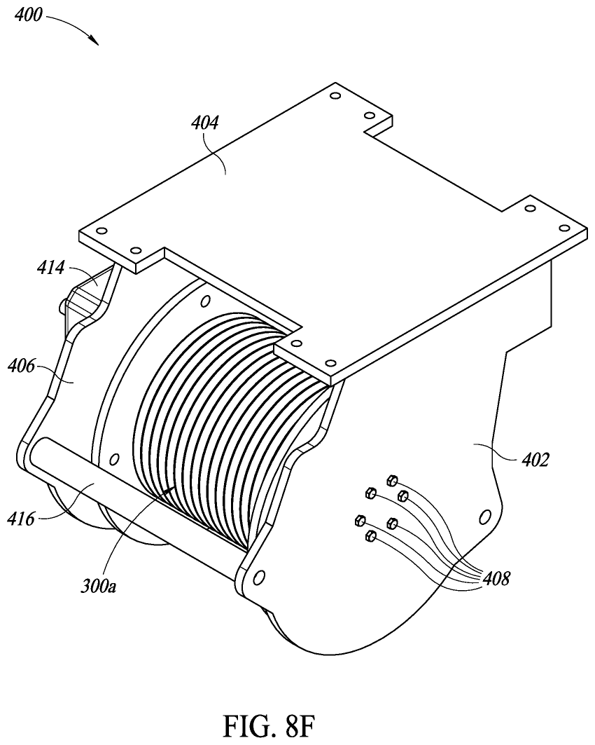

FIG. 8A is a rear side view of a mounting system 400 coupled to the first embodiment 300a of the winch assembly 300 as discussed above with respect to FIGS. 5A-5D. FIG. 8B is a front side view of the mounting system 400. FIG. 8C is a top plan view of the mounting system 400. FIG. 8D is a bottom plan view of the mounting system 400. FIG. 8E a rear perspective view of the mounting system 400. FIG. 8F is a front perspective view of the mounting system 400.

The mounting system 400 includes a first plate 402, a second plate 404, and a third plate 406 that are coupled to each other. The plates 402, 404, 406 may be referred to as fixing components that can be coupled to an external surface of a vehicle. The plates 402, 404, 406 may be welded together or physically coupled together by fasteners (e.g., set-screws, screws, bolts, rivets, nuts, snap-fit etc.). The first plate 402 and the third plate 406 are transverse to the second plate 404, and the second plate 404 extends from the first plate 402 to the third plate 406.

The first plate 402 is coupled to the end 340 of the shaft 322 by a plurality of fasteners 408 (e.g., set-screws, screws, bolts, rivets, nuts, snap-fit, etc.). The third plate 406 is coupled to the end 326 of the shaft 322 by a plurality of fasteners 410 (e.g., set-screws, screws, bolts, rivets, nuts, snap-fit, etc.). The mounting system 400 is configured to be permanently or removably coupled to an exterior of a vehicle. The mounting system 400 may be permanently coupled to the exterior of the vehicle by welding or some other permanent coupling technique. The mounting system 400 may be removably coupled to the exterior of the vehicle by fasteners (e.g., set-screws, screws, bolts, rivets, nuts, snap-fit, etc.).

A member 412 extends from the first plate 402 to the third plate 406. The member 412 is coupled to the first plate 402 and the third plate 406. The member 412 may be integral the first plate 402 and the third plate 406 such that the first plate 402, the third plate 406, and the member 412 are made of a continuous piece of material. The member 412 may be a retainer member that holds a line, a rope, a cord, a chain, or the like in place to avoid unraveling once the line, the rope, the cord, the chain, and the like has been wound up and coiled on the rotation component 302.

An electrical component 414 is coupled to a first side of the third plate 406 that is opposite to a second side of the third plate 406 to which the end 326 is coupled. The electrical component 414 is in electrical communication with the power drive 306. For example, the shaft 322 of the power drive 306 may be hollow such that electrical wires pass through the shaft 322 from the electrical component 414 to the motor component 348 of the power drive 306. The electrical component 414 may be a user interface (e.g., a touch screen, a plurality of buttons and knobs, a digital screen, an analog interface, etc.) that an operator or maintenance employee may interact with by providing inputs to select parameters at which the winch assembly 300 will operate. For example, these parameters may be rotation speed, rotations per minute (RPM), thermal management parameters (e.g., temperature thresholds), torque output, power output, safety parameters, diagnostic features, or some other operation parameters, safety parameters, or diagnostic parameters for controlling and maintaining the power drive 306 and the first embodiment 300a as a whole. In some embodiments, the power drive 306 may be in communication with the electrical component 414 through a wireless connection such as Bluetooth, Wi-Fi, or some other wireless connection.

A member 416 extends from the first plate 402 to the third plate 406. The member 416 is coupled to the first plate 402 and the third plate 406. The member 416 may be integral the first plate 402 and the third plate 406 such that the first plate 402, the third plate 406, and the member 416 are made of a continuous material. The member 416 may be a guide member that guides a line, a rope, a cord, a chain, or the like while being wrapped up and coiled by the first embodiment 300a reducing the likelihood of tangles or knots forming as the line, the rope, the cord, the chain, or the like is wound up and coiled on the rotation component 302.

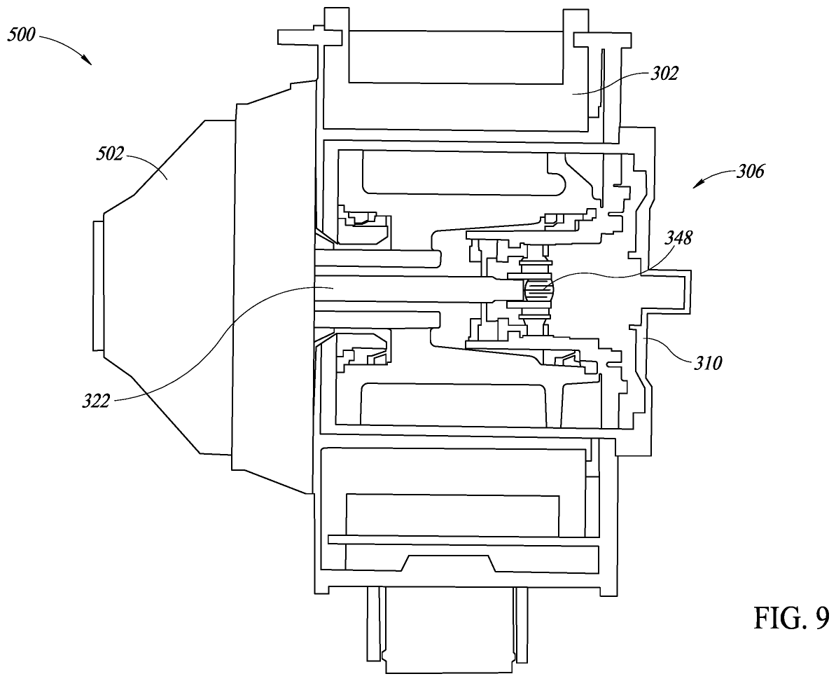

FIG. 9 is a more detailed cross-sectional view of an embodiment of a winch assembly 500 that includes the power drive 306 with the motor component 348, and a planetary gear set 502 that is mechanically coupled to the power drive 306. The power drive 306 is similar to the power drive 306 in FIGS. 6B and 7B in that the shaft 322 in FIG. 9 rotates similar to the shaft 370 in FIGS. 6B and 7B.

The motor component 348 is mechanically coupled to the planetary gear set 502 through the shaft 322. The planetary gear set 502 is mechanically coupled to the rotation component 302 such that the rotation of the shaft 322 by the motor component 348 is translated to the planetary gear set 502. The gears of the planetary gear set 502 then rotate accordingly to translate the rotation of the shaft 322 to the rotation component 302 to wind up and coil a line, a cord, a rope, a chain, or the like. The planetary gear set 500 may be a combination of a sun gear, multiple planet gears, a ring gear, or any number of gears that provide the necessary transfer of rotational movement from the shaft 322 to the rotation component 302. The planetary gear set 500 may be coupled to the rotation component by a member, a plurality of members, or some other component adapted to translate the rotation of the gears in the planetary gear set 500 to the rotation component 302.

In some embodiments, the planetary gear set 500 may include, or be mechanically coupled to or cooperating with, an electrical component or a combination of electrical components such that when the rotation component 302 is rotated as a line, a rope, a cord, a chain, or the like is pulled to be unwound by an operator, the rotation of the rotation component 302 is then converted by the electrical component within or electrically coupled to the planetary gear set 502 to electrical power. This electrical power may then sent to a battery bank of the vehicle, an alternator of the vehicle, or an external power source for storage. This power generated by the electrical component(s), e.g., an alternator may be referred to as generated power or some other terminology for the generation of power. In the other embodiments of the winch assemblies of the present disclosure, a power drive 306 may include electrical components that are adapted to generate power as discussed above with respect to the planetary gear set 500 or the rotation of the rotation component 302.

Another form of power generated in accordance with disclosed embodiments may be electrical power that is regenerated, recovered, or recuperated when using the power drive 306 to brake and/or stop the rotation component 302 from rotating. As the power drive 306 is used to brake the winch, the load on the winch drives the power drive 306. The rotation of the power drive 306 generates electrical power that can be recovered, regenerated, or recuperated and sent to a battery bank of the vehicle or an external power source for storage. This regeneration, recuperation, or recovering of power may be referred to as regenerative power, recuperative power, recovering power, or some other terminology or combination of terminology for the recovery of power previously input to an articulation member. For example, if a winch assembly of the present disclosure is utilized to lift a platform, a boom, or a ladder, when the platform, the boom, or the ladder is lowered some of the gravitational energy may be regenerated, recuperated, or recovered by the winch assembly.

In some of the above embodiments of the winch assembly, multiple power drives or multiple electric motors may be included within the rotation component of the winch assembly to increase the amount of torque and power available or output depending on the application or use of the winch assemblies as discussed above. Furthermore, some of the power drives may be turned on for some applications and some may remain off for some applications. For example, pulling lumber or heavy equipment may require a greater amount of power as compared to pulling a vehicle out of mud or out of a precarious situation. In view of this, a greater number of power drives may be turned on to pull lumber instead of pulling a vehicle of mud. Furthermore, an operator may select the number of power drives that are turned on and the amount of power drives that remain off for situational use as desired and to reduce strain on multiple power drives within the system to increase the usable lifespan of the system.

As discussed above, the embodiments of the winch assemblies of the present disclosure may be fully inset, partially inset, or external to a rotation component (e.g., a spool, a drum, a cylinder, a spindle, a bobbin, etc.) of the winch assemblies. By providing a power drive with an electric motor in the manner as discussed in the present disclosure, the winch assembly may be reduced significantly in size and weight as compared to a hydraulic systems utilized for winch applications. The power drive powers the rotation of the winch in a much smaller package required for the gaskets, hoses, and other features of a hydraulic system used to power the rotation. This reduction in size reduces the overall profile of the winch assembly as compared to a winch assembly that utilizes a hydraulic system.

Even more so, the power drive with the electric motor provides much greater accuracy of control when compared to the hydraulic system. For example, the amount of length of wire wound up may be more closely controlled using electrically powered embodiments described herein compared to a device that is powered by a hydraulic system. For example, rotation of the rotation component in accordance with embodiments of the present disclosure can be started and stopped or otherwise controlled more precisely to complete a task (e.g., pulling a vehicle, pulling lumber, etc.) compared to the preciseness of control achievable with a hydraulic system powered system, that utilizes hydraulic fluid which is slow to respond to actions intended to start or stop or otherwise control rotation.

A power drive including an electric motor is desirable as a user or operator can select or manage any number of control parameters at which the winch assembly can be operated for optimal performance. Furthermore, safety parameters such as thermal management may be selected by an operator as well as other safety parameters. For example, thermal management may include selecting a threshold temperature that the winch assembly may turn off and lock up to avoid damaging internal components within the winch assembly as a whole. This customizable approach to the selection of parameters allows the winch assembly to be utilized at optimal capacity, in a predictable and tailored manner, and in a safe manner depending on the situation at hand based on an operators experience or suggested parameters for the situation.

Further, this customizable approach allows for a power drive of an electric motor to be more efficient than other conventional winches or rotational components that utilized a hydraulic system. The selection of various customizable features may allow a user to select efficiency parameters and thresholds such as maximum power output, minimum power output, maximum rotation speed, minimum rotation speed, or other similar such parameters allowing a user or operator to maximize efficiency of a power drive or an electric motor depending on situational use.

The regeneration, recuperation, recovering, or generation of power due to rotation of a rotation component when a user or operator unwinds a line, a rope, a cord, a chain, or the like on the rotation component of the winch assembly is desirable. This generation or recovery of power can be utilized to increase the lifespan of a battery bank within a vehicle. For example, this power can be sent to the battery bank within the vehicle to partially recharge the battery bank. This partial recharging of the battery bank increases the time between when the battery bank or pieces of the battery bank need to be replaced within the vehicle. This recharging of the battery bank reduces overall long term costs to run the vehicle as well as the time between battery replacements is increased and the costs associated with battery replacement are reduced due to the lesser frequency of replacement. In other words, this regeneration, recuperation, recovering, or generation of power due to rotation of a rotation component allows for electrical motor and a vehicle as a whole to have overall greater power efficiency.

The ability to conduct a diagnostic review of the winch assembly by coupling a diagnostic system to the power drive is desirable as an operator or user can easily and quickly determine a point of failure within the power drive, and can easily determine if a replacement is necessary. For example, a handheld diagnostic system may be coupled to electrical connections of the winch assembly that are provided to perform a diagnostic review of the winch assembly. This ease of review without specialized equipment is desirable and reduces costs and time for determining a point of failure within power drive or winch assembly associated with the power drive. This ability to perform a quick diagnostic review of the winch assembly reduces the down time and reduces the complexity for repairing or replacing parts as an operator can easily determine the necessary parts to fix the winch assembly on the fly without having to wait for a maintenance crew.

Other applications of a power drive being electrically coupled to a rotation component include, but are not limited to, a street sweeper brush, a cement mixer, a pump, an extension component (e.g., ladder, boom, platform, etc.), or some other mechanical component that supports power regeneration, recovery or generation when the mechanical component is retracted, extended, rotated, stopped, or in use. For example, a power drive may be internally inset into a street sweeper brush in a similar fashion as discussed with respect to the winch assembly in the present disclosure, and, as a street sweeper drives along a road when the brush is not in use, the brush may rotate if brought into contact with the ground surface generating power and sending the generated power to a battery bank. Alternatively, a power drive may be implemented in any of the other articulation systems in a similar fashion as well.

Although the above discussions disclose some of the desirable features of utilizing a power drive with an electric motor, there are other additional desirable features that have not be discussed for the sake of simplicity and brevity of the present disclosure. Accordingly, the above desirable features is not a complete list of each and every desirable feature.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A device, comprising:
a rotation component;
a power drive mechanically coupled to the rotation component, the power drive including:
an articulation component mechanically cooperating with the power drive and the rotation component; and
an electric motor mechanically cooperating with the articulation member, the electric motor configured to, in operation, rotate the articulation member.

2. The device of claim 1, wherein the articulation component is selected from a group comprising a direct drive component, an indirect drive component, and a multi-drive component.

3. The device of claim 1, wherein the rotation component further comprises a casing including an external surface, an internal surface, and an opening extending through the case from the external surface to the internal surface.

4. The device of claim 3, wherein the electric motor and the articulation member of the power drive are enclosed within the casing of the rotation component.

5. The device of claim 3, wherein the articulation member is mechanically coupled to the internal surface of the casing.

6. The device of claim 1, wherein the power drive is laterally adjacent to the rotation component and the electric motor is external the rotation component.

7. The device of claim 1, wherein the power drive is partially encased within the rotation component.

8. The device of claim 1, wherein the power drive is fully encased in the rotation component.

9. The device of claim 1, wherein the rotation component is at least one of a drum of a winch, a sweeper brush component of a street sweeper, a drum of a cement mixer, or an extending component of a ladder, a boom, or a platform.

10. A winch assembly, comprising:
a housing including a first external surface, an first internal surface, and an first internal cavity surrounded by the first internal surface;
a power drive mechanically cooperating with the housing and within the housing, the power drive including:
a casing having a second external surface, a second internal surface, and a second internal cavity surrounded by the second internal surface;
an electric motor coupled to the second internal surface of the casing; and
a first member extending from the electric motor to the internal surface of the casing, the first member couples the electric motor to the casing;
a first fixing component coupled to the power drive, the first fixing component fixedly couples the power drive to a vehicle.

11. The winch assembly of claim 10, wherein the second external surface abuts the first internal surface and the casing is coupled to the housing.

12. The winch assembly of claim 11, wherein the electric motor is configured to, in operation, rotate the member.

13. The winch assembly of claim 12, further comprising a second fixing component and wherein:
the casing further comprising a first opening at a first end and a second opening at a second end opposite to the first end; and
the power drive further comprising a shaft that extends through the first opening and the second opening, the shaft including:
a first end coupled to the first fixing component; and
a second end opposite to the first end, the second end coupled to the second fixing component.

14. The winch assembly of claim 10, wherein the second external surface is spaced apart from the first internal surface.

15. The winch assembly of claim 14, wherein:
the casing further comprising a first opening at a first end and a second end opposite to the first end; and
the power drive further comprising a shaft extends through the first opening and is coupled to the electric motor, the electric motor is configured to, in operation, rotate the shaft.

16. The winch assembly of claim 15, further comprising a second member extending from the shaft to the first internal surface, the second member couples the shaft to the first internal surface.

17. The winch assembly of claim 16, wherein the second end of the casing is coupled to a first one of the plurality of fixing components and the housing is coupled to a second one of the plurality of fixing components.

18. A winch assembly, comprising:
a rotation component having an first external surface, a first internal surface, and a first internal cavity surrounded by the first internal surface, the rotation component including:
a first cover at a first end; and
a second cover at a second end opposite to the first end;
a power drive fully within the internal cavity of the rotation component, the power drive including:
a casing having a second external surface, a second internal surface, a second internal cavity surrounded by the second internal surface, and an opening extending from the second internal surface to the second external surface;
an articulation member extends through the opening and is mechanically cooperating with the rotation component; and
an electric motor within the second internal cavity and coupled to the internal surface of the casing, the electric motor mechanically cooperating with the articulation member, the electric motor configured to, in operation, rotate the articulation member.

19. The winch assembly of claim 18, wherein:
the first cover further comprising a first reception portion with a first portion at the first external surface and a second portion at the first internal surface; and
the second cover further comprising a second reception portion at the first external surface.

20. The winch assembly of claim 19, further comprising:
a first bearing component in the first portion of the first reception portion, the first bearing component mechanically cooperating with a first mounting component;
a second bearing component in the second portion of the first reception portion, the second bearing component mechanically cooperating with the casing; and
a third bearing component in the second reception portion mechanically cooperating with a second mounting component.
